(19) United States
(12) Patent Application Publication
(10) Pub. No.: US 2025/0047153 A1
(43) Pub. Date: Feb. 6, 2025

(54) ROTOR FOR AN ELECTRIC MACHINE HAVING A COOLING DUCT IN A POLE SEPARATOR

(71) Applicant: VALEO EAUTOMOTIVE GERMANY GMBH, Erlangen (DE)

(72) Inventors: Nico WOLF, Bad Neustadt a.d. Saale (DE); Regina NOACK, Bad Neustadt a.d. Saale (DE); Alexander SCHLERETH, Bad Neustadt a.d. Saale (DE); Christoph WIECZOREK, Bad Neustadt a.d. Saale (DE); Carsten SIEPKER, Bad Neustadt a.d. Saale (DE)

(73) Assignee: VALEO EAUTOMOTIVE GERMANY GMBH, Erlangen (DE)

(21) Appl. No.: 18/720,174

(22) PCT Filed: Dec. 12, 2022
(86) PCT No.: PCT/EP2022/085435

§ 371 Date: Jun. 14, 2024

(30) Foreign Application Priority Data
Dec. 17, 2021 (DE) 10 2021 133 675.9

(51) Int. Cl. H02K 1/32; H02K 1/26; H02K 3/24; H02K 15/02; H02K 15/06

(52) U.S. Cl. CPC H02K 1/325; H02K 1/26; H02K 3/24; H02K 15/026; H02K 15/062

(57) ABSTRACT

A rotor for an electric machine includes a rotor shaft and a laminated core which is arranged on the rotor shaft and formed from stacked electrical laminations and which has radially outwardly projecting laminated core protrusions. Rotor windings are each wound around a laminated core protrusion. A pole separator is arranged between two adjacent laminated core protrusions and has a cooling duct, which runs in the pole separator, for a coolant.

The invention relates to a rotor for an electric machine, to an electric machine having a rotor, to a vehicle having an electric machine, and to a method for producing a rotor.

The rotor has a rotor shaft and a laminated core arranged on the rotor shaft and formed from stacked electrical laminations. The rotor, together with a stator, belongs to an electric machine.

Electric machines of this type are increasingly used in electrically driven vehicles and hybrid vehicles, predominantly as electric motors for driving a wheel or an axle of such a vehicle.

Such an electric motor is usually mechanically coupled to a gear mechanism for speed adaptation. Moreover, the electric motor is typically electrically coupled to an inverter which generates AC voltage, for example multi-phase AC voltage, for the operation of the electric motor, from DC voltage that is provided from a battery.

It is also possible to operate an electric machine having such a rotor as a generator for recuperating kinetic energy of a vehicle. For this purpose, the kinetic energy is first converted into electrical energy and then into chemical energy of a vehicle battery.

In a certain type of electrically excited synchronous motors (EESM), the rotor has rotor windings which are fed with direct current in order to generate a magnetic excitation field. If a rotating field is generated with the stator windings of an associated stator, this brings about an action of force on the rotor such that the latter rotates synchronously with the stator rotating field.

However, the rotor windings are greatly heated in the process, and therefore cooling is required. The cooling may be undertaken, for example, by spraying coolant onto the axial sides of the rotor. However, this type of cooling acts only superficially and therefore has little effect.

The invention is therefore based on the object of specifying a rotor for an electric machine which can be better cooled during operation of the electric machine.

To achieve this object, a rotor having the features of claim 1 is provided.

The rotor according to the invention comprises a laminated core, which is arranged on a rotor shaft and formed from stacked electrical laminations and which has radially outwardly projecting protrusions, rotor windings which are each wound around a protrusion of the laminated core (laminated core protrusion), and a pole separator which is arranged between two adjacent protrusions of the laminated core and in which a cooling duct for a coolant runs.

The invention is based on the finding that improved cooling can be achieved by the coolant being supplied to the rotor windings via a cooling duct which is located in a pole separator. The coolant can flow along the rotor windings in the pole separator, so that the heat arising during operation of the electric machine is dissipated. In comparison with a conventional rotor, in which only coolant is sprayed onto the axial sides, the rotor according to the invention can be cooled substantially better and more homogeneously.

In addition, the pole separator creates a multifunctional component with which the rotor is mechanically stabilized, protected against environmental influences and is cooled.

The electric machine can be, for example, an electrically excited synchronous motor (EESM).

Optionally, the rotor has a first end plate, which is arranged at an axial end of the laminated core, and a second end plate, which is arranged at the opposite axial end of the laminated core. The two end plates are used to hold the electric laminations of the laminated core together and each have radially outwardly projecting end plate protrusions, which in particular can be arranged along the circumference of an end plate. The end plate protrusions are also designated as “plate extensions” and, inter alia, are used to hold the rotor windings in an intended position.

The laminated core protrusions of the laminated core are also designated as “teeth” and can in particular be arranged along the circumference of the laminated core. Apart from being wound around a laminated core protrusion, a rotor winding can be wound around an end plate protrusion of the first end plate and an axially opposite end plate protrusion of the second end plate, between which the laminated core protrusion extends axially.

Preferably, the cooling duct runs from an axial side of the laminated core as far as an opposite axial side of the laminated core, for example in a straight line and in the axial direction. Accordingly, the rotor windings can be cooled over their entire axial length. As a result of the cooling, the temperature of the rotor can be kept below a defined limiting value even during continuous operation at high output.

In the rotor according to the invention, provision can be made for the pole separator to have an inner section, which is arranged between the two rotor windings, and an outer section, which is arranged radially outside the two rotor windings. In particular, the rotor windings can be mechanically stabilized and cooled by the inner section. Since the rotor windings preferably consist of lacquered copper wire, good thermal conductivity and thermal dissipation via the pole separator is ensured. In particular, the ends of the laminated core protrusions can be mechanically stabilized and cooled by the outer section.

The pole separator can be produced inexpensively from a plastic material by using the injection molding process. Alternatively, the pole separator can also be produced by extrusion from a metal alloy, for example from an aluminum alloy.

Within the context of the invention, it is preferred for the inner section of the pole separator to be embedded in a potting compound with which the two rotor windings are potted. As a result, the rotor windings are stabilized and the heat transfer from the rotor windings to the pole separator is improved.

In the rotor according to the invention, the cooling duct can run in the inner section of the pole separator and/or the outer section of the pole separator. The size and the position of the cooling duct can thus be matched to the respective cooling requirements and the space that is available. If the cooling requirements are low, it may be sufficient if the cooling duct is located in the inner section of the pole separator. If there is a greater need for cooling, the cooling duct can extend from the inner section as far as into the outer section.

One refinement of the invention provides for the cooling duct to have a circular cross section. Such a cooling duct is distinguished by low friction-induced flow losses. According to an alternative refinement, the cooling duct can have a Y-shaped cross section. Such a cooling duct can optimally be arranged in a pole separator which has an inner section, which is arranged between two adjacent rotor windings, and an outer section, which is arranged radially outside the two rotor windings. In this case, the Y-shaped cooling duct or its cross section can extend from the inner section as far as into the outer section. As an alternative to the aforementioned cross-sectional shapes, the cooling duct can also have a rectangular, square, triangular, trapezoidal, hexagonal or ellipsoidal cross section. In principle, a larger cross section permits the dissipation of a larger quantity of heat.

A very particularly preferred refinement of the invention provides for the cooling duct to open in an end cap of the rotor. The end cap can be arranged on an axial side of the laminated core, in particular can cover an end cap positioned there. Likewise, there can be a second end cap, in which the cooling duct likewise opens and which optionally covers a second end cap, on the opposite axial side of the cooling duct.

The end caps can seal off the interior of the rotor from the outside and each have a passage opening for coolant, of which one is used as an inlet and the other as an outlet. An associated nozzle for coolant, with which coolant can be sprayed into the inlet, can be arranged in a housing of the electric machine. Alternatively, a connection for an external coolant line can also be integrated in an end cap.

In order to improve the cooling action, the pole separator of the rotor according to the invention can have a plurality of cooling ducts. As a result, a larger quantity of coolant can flow through the pole separator. Furthermore, the stability of the pole separator can be increased with a plurality of cooling ducts. The cooling ducts can be arranged one after another in the radial direction. As an alternative thereto, the cooling ducts can be arranged one after another in the circumferential direction, for example in the intermediate space formed between two rotor windings. However, it is also possible for a plurality of cooling ducts to be arranged one after another in the radial direction in the pole separator and, in addition, for a plurality of cooling ducts to be arranged one after another in the circumferential direction. For instance, the former can be arranged in the inner section and the latter in the outer section of the pole separator.

In a further embodiment of the invention, the rotor has a plurality of pole separators of the type described. The pole separators are each arranged between two (different) adjacent laminated core protrusions of the laminated core. The pole separators improve the cooling of the rotor, increase the stability of the latter and simplify the potting of the intermediate spaces between adjacent rotor windings with potting compound. The number of pole separators can correspond to or differ from the number of poles (pole number) of the rotor.

The coolant can be supplied to the cooling ducts in different ways. For example, the rotor shaft can have one or more bores, through which the coolant flows from a central cooling duct running in the rotor shaft into a cavity delimited by an end cap of the rotor. The coolant can then flow into the cooling duct from the cavity. Alternatively, the coolant can be sprayed into the cooling ducts by a nozzle fixedly connected to the stator of the electric machine. For this purpose, an end cap of the rotor can have one or more passage openings through which the coolant is sprayed.

In addition, the invention relates to an electric machine having a rotor of the type described and a stator which surrounds the rotor. The rotor is rotatable with respect to the stator. The stator can have a further laminated core (stator core) which is formed from stacked electrical laminations. In addition, the stator may have windings of electrical conductors, for example, in the form of coil windings or flat wire windings.

Furthermore, the invention relates to a vehicle having such an electric machine which is provided to drive the vehicle. The machine can in particular drive a wheel or an axle of the vehicle.

The invention also relates to a method for producing a rotor of the type described. The method according to the invention comprises the following steps: arranging the laminated core on the rotor shaft, producing the rotor windings by winding lacquered copper wire around the protrusions of the laminated core, inserting pole separators having a cooling duct in each case between two adjacent protrusions of the laminated core, arranging a first end cap on a first axial side of the laminated core, arranging a second end cap on the second axial side of the laminated core, potting intermediate spaces between adjacent rotor windings and the pole separators with a potting compound, so that the pole separators are each embedded in the potting compound.

Preferably, the rotor is positioned for the potting such that its axis of rotation runs vertically, and the potting compound is introduced through a filling opening in an end cap of the rotor, wherein the end cap preferably also has a venting opening. The venting opening permits the escape of air, so the intermediate spaces in the rotor can be completely potted.

The invention will be explained below by means of exemplary embodiments with reference to the figures. The figures are schematic illustrations in which:

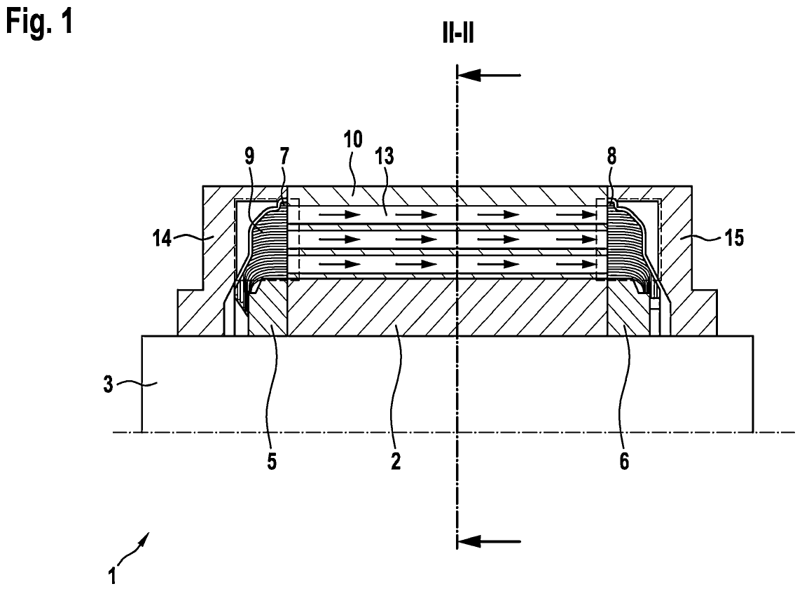

FIG. 1 shows a sectioned side view of a rotor according to the invention having a pole separator according to a first exemplary embodiment,

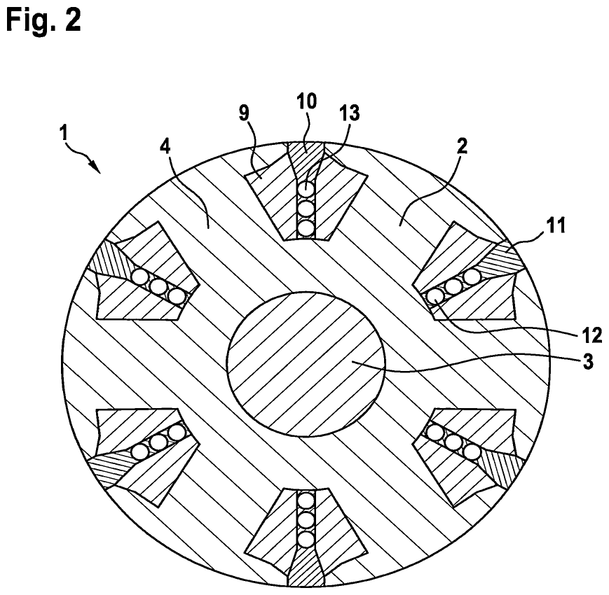

FIG. 2 shows a section along the line II-II of FIG. 1,

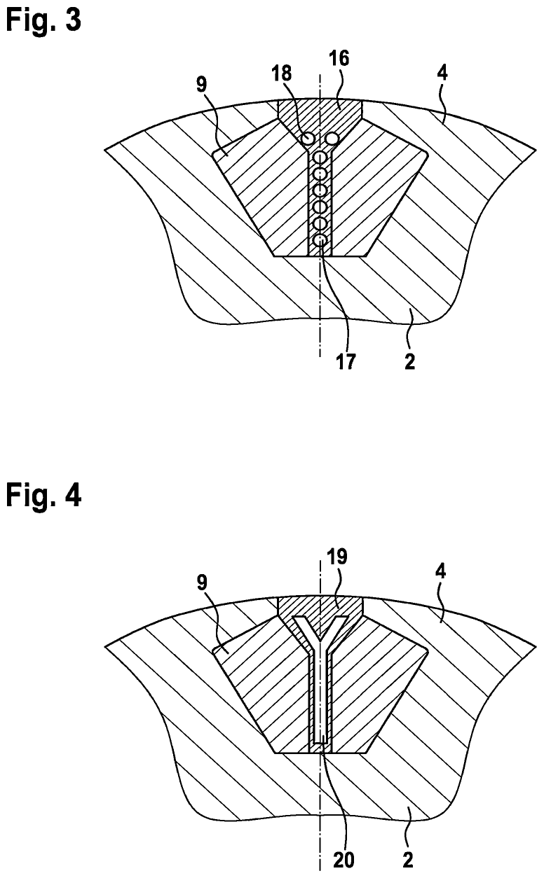

FIG. 3 shows an enlarged view in the region of a pole separator according to a second exemplary embodiment,

FIG. 4 shows an enlarged view in the region of a pole separator according to a third exemplary embodiment, and

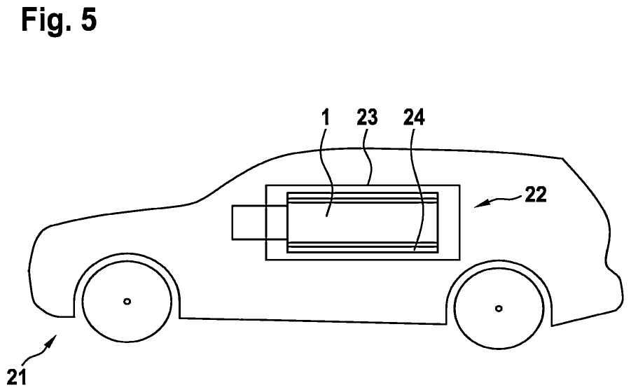

FIG. 5 shows a vehicle according to the invention having an electric machine.

The rotor 1 according to a first exemplary embodiment of the invention, shown in a sectioned side view in FIG. 1 and in an axial view sectioned along the line II-II of FIG. 1 in FIG. 2, is intended for an electric machine which is used as an electric motor for driving a vehicle.

The rotor 1 comprises a cylindrical laminated core 2 which is formed from stacked electrical laminations and surrounds a rotor shaft 3 with a form fit and/or force fit. The electrical laminations can be identically formed punched parts. The laminated core 2 has a plurality of laminated core protrusions 4 (“teeth”) projecting radially outward, as can best be seen in FIG. 2. End sections of the laminated core protrusions 4 are widened in the circumferential direction.

A first end plate 5 is located on a first axial side of the laminated core 2. A second end plate 6 is located on the opposite, second axial side of the laminated core 2. The end plates 5, 6 have an electrically insulating coating or are produced from an electrically non-conducting material such as a plastic. The end plates 5, 6 each have radial end plate protrusions 7, 8 (also “plate extensions”), around which a plurality of rotor windings 9 are wound. The rotor windings 9 consist of lacquered copper wire.

FIG. 2 reveals that a respective pole separator 10 is arranged between two adjacent laminated core protrusions 4. The rotor 1 has six rotor poles and six pole separators 10.

Such a pole separator 10 is formed as a plastic profile and is inserted axially between two adjacent rotor windings 9, which are wound around two adjacent laminated core protrusions 4. The pole separator 10 closes a free space formed between the two rotor windings 9 and the two laminated core protrusions 4. For this purpose, the cross section of the pole separator 10 is matched to the shape of the free space.

The pole separator 10, formed in one piece, comprises a wider, approximately trapezoidal radially outer section 11 and an approximately rectangular radially inner section 12. Three cooling ducts 13 for a coolant, which are lined up in the radial direction, run in the pole separator 10.

The joints between the rotor windings 9 and the pole separator 10 can be potted with a potting compound. This has the effect that the rotor windings 9 maintain their position even at high rotational speeds, and improves the heat transfer from the rotor windings 9 and/or the laminated core 2 to the pole separator 10.

Again with reference to FIG. 1, it can be seen that the cooling ducts 13 extend in the pole separators 10 over their entire axial length. A respective end cap 14, 15, which is penetrated by the rotor shaft 3, is located on both axial sides of the rotor 1.

The arrows in FIG. 1 indicate the flow direction of the coolant by way of example. The coolant can be, inter alia, a liquid, a gas or an oil. All the cooling ducts 13 run in a straight line and in the axial direction. Since the cooling ducts 13 lead along the rotor windings 9, heat is transferred from the rotor windings 9 to the coolant flowing in the cooling ducts 13 and is dissipated. As a result, the rotor windings 9 are cooled along their entire axial length.

In the exemplary embodiment illustrated in FIG. 1, an inlet (not illustrated) for coolant is located on the left-hand side. The inlet can be configured differently. For example, the rotor shaft 3 can have one or more bores, through which the coolant from a central cooling duct arranged in the rotor shaft 3 is introduced into the cavity delimited by the end cap 14. From there, the coolant can reach the cooling ducts 13.

Alternatively, the end cap 14 can have one or more passage openings, through which the coolant is sprayed into the cooling ducts 13 through the end cap 14 from a nozzle arranged in the housing of the electric machine.

On the opposite side, on the right in FIG. 1, an outlet (not illustrated) for the coolant, corresponding to the inlet, is located within the end cap 15. The outlet can analogously either be formed as a passage opening in the end cap 15 or as a bore in the rotor shaft 3.

In the method for producing the rotor 1, the laminated core 2 formed from stacked electrical laminations and having the laminated core protrusions 4 projecting radially outward is arranged on the rotor shaft 3. Furthermore, the rotor windings 9 are produced by winding lacquered copper wire around the laminated core protrusions 4 of the laminated core 2. The pole separators 10 are then each inserted axially between two adjacent protrusions of the laminated core 2. After that, the two end caps 14, 15 are fastened to the two axial sides of the laminated core 2 by being pressed onto the end plates 5, 6.

The joints between the rotor windings 9 and the pole separators 10 are potted with a potting compound, as a result of which the rotor windings 9 and the pole separators 10 are embedded in the potting compound. For the potting, the rotor 1 is expediently moved into a vertical position in relation to its axial direction. The potting compound is introduced through a filling opening (not shown), which is formed in one of the end caps. This end cap preferably also has a venting opening.

FIG. 3 shows an enlarged view of a pole separator 16 according to a second exemplary embodiment of the invention. The radially outer section of the pole separator 16 closes a gap between two adjacent laminated core protrusions 4. The radially inner section thereof is located between two adjacent rotor windings 9 and has a plurality of cooling ducts 17 which are arranged along a radial axis (dash-dotted line) and which each have a circular cross section. The radially outer section of the pole separator 16 has two cooling ducts 18 arranged on both sides of the radial axis in the circumferential direction, of which the cross sections correspond to the cooling ducts 17 in the inner section.

FIG. 4 is a view similar to that of FIG. 3 and shows a pole separator 19 according to a third exemplary embodiment of the invention, which has only a single cooling duct 20. The cooling duct 20 has a Y-shaped cross section, which extends from a radially inner section of the pole separator 19 into a radially outer section of the pole separator 19. In the radially inner section of the pole separator 19, the cross section has a straight first section extending along a radial axis (dash-dotted line). In the radially outer section of the pole separator 19, the cross section has two straight sections, which each branch off from the first section, run obliquely relative to the radial axis along the rotor windings 9 and are aligned symmetrically relative to each other with respect to the radial axis.

FIG. 5 shows a vehicle 21 having an electric machine 22 which is used for driving the vehicle 21. The electric machine 22 has a housing 23 in which the rotor 1 and a stator 24, which surrounds the rotor 1, are accommodated.

### LIST OF DESIGNATIONS

1 Rotor
2 Laminated core
3 Rotor shaft
4 Laminated core protrusion
5 End plate
6 End plate
7 End plate protrusion
8 End plate protrusion
9 Rotor winding
10 Pole separator
11 Outer section
12 Inner section
13 Cooling duct
14 End cap
15 End cap
16 Pole separator
17 Cooling duct
18 Cooling duct
19 Pole separator
20 Cooling duct
21 Vehicle
22 Electric machine
23 Housing
24 Stator

1. A rotor for an electric machine, comprising:
a rotor shaft,
a laminated core, which is arranged on the rotor shaft and formed from stacked electrical laminations and which has radially outwardly projecting laminated core protrusions,
rotor windings, which are each wound around a laminated core protrusion, and
a pole separator which is arranged between two adjacent laminated core protrusions and in which a cooling duct for a coolant runs.

2. The rotor as claimed in claim 1, wherein the cooling duct extends from one axial side of the laminated core to the opposite axial side of the laminated core.

3. The rotor as claimed in claim 1, wherein the pole separator has an inner section, which is arranged between two adjacent rotor windings, and an outer section, which is arranged radially outside the two rotor windings.

4. The rotor as claimed in claim 3, wherein the inner section is embedded in a potting compound with which the two rotor windings are potted.

5. The rotor as claimed in claim 3, wherein the cooling duct runs in the inner section and/or the outer section.

6. The rotor as claimed in claim 1, wherein the cooling duct has a circular or Y-shaped cross section.

7. The rotor as claimed in claim 1, wherein the cooling duct opens in an end cap of the rotor.

8. The rotor as claimed in claim 1, wherein the pole separator has a plurality of cooling ducts corresponding to the cooling duct.

9. The rotor as claimed in claim 1, having a plurality of pole separators corresponding to the pole separator, which are each arranged between two adjacent laminated core protrusions of the laminated core.

10. An electric machine, having a rotor as claimed in claim 1 and a stator surrounding the rotor.

11. A vehicle having an electric machine as claimed in claim 10, which is provided to drive the vehicle.

12. A method for producing a rotor as claimed in claim 1, having the following steps:
arranging the laminated core on the rotor shaft,
winding the rotor windings around the laminated core protrusions of the laminated core,
inserting the pole separator between two adjacent laminated core protrusions of the laminated core, and
potting the rotor windings with a potting compound, so that the pole separator is embedded in the potting compound.

13. The method as claimed in claim 12, wherein the rotor is positioned for the potting such that its axis of rotation runs vertically, and the potting compound is introduced through a filling opening in an end cap, wherein the end cap preferably also has a venting opening.

14. The rotor as claimed in claim 2, wherein the pole separator has an inner section, which is arranged between two adjacent rotor windings, and an outer section, which is arranged radially outside the two rotor windings.

15. The rotor as claimed in claim 4, wherein the cooling duct runs in the inner section and/or the outer section.

16. The rotor as claimed in claim 2, wherein the cooling duct has a circular or Y-shaped cross section.

17. The rotor as claimed in claim 2, wherein the cooling duct opens in an end cap of the rotor.

18. The rotor as claimed in claim 2, wherein the pole separator has a plurality of cooling ducts corresponding to the cooling duct.

19. The rotor as claimed in claim 2, having a plurality of pole separators corresponding to the pole separator, which are each arranged between two adjacent laminated core protrusions of the laminated core.

20. An electric machine, having a rotor as claimed in claim 2 and a stator surrounding the rotor.
